(19) United States
(12) Patent Application Publication
(10) Pub. No.: US 2002/0067695 A1
(43) Pub. Date: Jun. 6, 2002

(54) METHOD FOR INTERFACING AN ATM NETWORK TO A PC BY IMPLEMENTING THE ATM SEGMENTATION AND REASSEMBLY FUNCTIONS IN PC SYSTEM SOFTWARE

(76) Inventors: MARK L. SKARPNESS, HILLSBORO, OR (US); NIRANJAN PARAMPALLI, SANTA CLARA, CA (US)

Correspondence Address: KENT M. CHEN, BLAKELY, SOKOLOFF, TAYLOR & ZAFMAN, 12400 WILSHIRE BLVD., 7TH FLOOR, LOS ANGELES, CA, 90025

(21) Appl. No.: 09/263,918

(22) Filed: Mar. 5, 1999

(51) Int. Cl. H04L 12/26

(52) U.S. Cl. 370/230.1; 370/395.6

(57) ABSTRACT

The present invention describes a method and an apparatus for segmenting and reassembling ATM data. The invention uses the central processing unit (CPU) of a computer to perform segmentation and reassembly of data. By using the CPU of a computer, the present invention reduces the amount of hardware needed to perform transmission and reception of ATM data.

### BACKGROUND OF THE INVENTION

1. Field of the Invention

The present invention relates to computer systems. More particularly, the invention relates to a method and apparatus for segmenting and reassembling ATM data in an ATM interface.

2. Description of Related Art

Asynchronous transfer mode (ATM) is a connection-oriented cell switching technique in which cells are of a fixed length. Each cell includes a header of 5 bytes and a payload or information of 48 bytes. The header includes virtual channel information and is used in routing. The data portion may carry a variety of information types including voice, data, images, text and video. In recent years, ATM has become universally accepted as the transfer mode of choice for broadband integrated service digital networks (BISDN).

FIG. 1 illustrates a typical ATM cell structure of the prior art. ATM cell 100 includes a header 104 and an information field 108. The header is 5 bytes and the information field is 48 bytes to create an ATM cell of 53 bytes. The header is used to identify cells belonging to the same virtual channel and is used in appropriate routing. Each virtual channel preserves the sequence of the cells.

The header 104 of ATM cell 100 includes six elements including the generic flow control 112, the virtual path identifier 116, the virtual channel identifier 120, the payload type identifier 124 and a header error control 128. The header values are assigned during the connection set up and translated when switched from one section of a network to another section. In particular, the virtual path identifier (VPI) 116 and the virtual channel identifier (VCI) 120 control the routing of the cell.

Typically, in order to prepare and receive ATM data, data must undergo several layers of processing. The lowest layer, a physical layer, performs physical medium dependent functions such as bit timing functions and cell rate decoupling which inserts idle cells in a transmitting direction in order to adapt the rate of the ATM cells to the payload capacity of a transmission system and removes idle cells in the receiving direction. Above the physical layer is an ATM layer which performs header generation and extraction, cell multiplexing and demultiplexing, translation of VPI/VCI fields and generic flow control. An ATM adaptation layer above the ATM layer performs the adaption of the lower layers including the ATM layer and the physical layer to OSI higher layer protocols.

One of those layers, an ATM adaption layer function (AAL functions) is divided into two sublayers, typically, 1) a segmentation and reassembly (SAR) sublayer, and 2) a convergence (CS) sublayer. During transmission, the SAR sublayer performs segmentation of higher layer information into a size suitable for an ATM cell payload. When receiving ATM cells, the SAR sublayer reassembles the contents of the cells of a virtual connection into data units to be delivered to higher layers. The functions of the SAR sublayer are typically performed by hardware implemented in the computer such as a SAR chip. Examples of typical SAR chips are made by Integrated Device Technologies (IDT) of Santa Clara, Calif., and Motorola Corporation of Schaumburg, Ill.

Implementing the SAR in a chip has several disadvantages. A first disadvantage of implementing the SAR chip is cost. As the price points of personal computers (PCs) continue to decrease, the additional expense of SAR chips is undesirable. A second disadvantage of using SAR chips is the limited flexibility in changing other components coupled to the SAR chip. Thus, a more inexpensive and flexible method of implementing SAR functions is needed.

### SUMMARY OF THE INVENTION

In one embodiment, the present invention relates to a method of performing asynchronous transfer mode segmentation functions. In one embodiment of the invention, data to be sent is received. The data is segmented to generate a plurality of ATM cells. The plurality of ATM cells is buffered in a memory device. The buffered plurality of ATM cells undergoes traffic shaping prior to transmission of the plurality ATM cells on a network.

### BRIEF DESCRIPTION OF THE DRAWINGS

The advantages of the present invention will become more readily apparent to those ordinarily skilled in the art after reviewing the following detailed descriptions and accompanying drawings wherein:

FIG. 1 illustrates a typical ATM cell.

FIG. 2 illustrates a SAR ASIC coupled to a system as used in the prior art.

FIG. 3A and FIG. 3B illustrate a system to receive ATM cells which uses software implemented in the CPU to perform the SAR functions.

FIG. 4 is a block diagram showing the software SAR module coupled to a simplified ATM interface.

FIG. 5 is a flow diagram illustrating processor operations to perform segmentation and traffic shaping functions.

FIG. 6 shows transfer of data from various channels to a traffic shaper.

FIG. 7 is a flow diagram illustrating operation of a software SAR when receiving data.

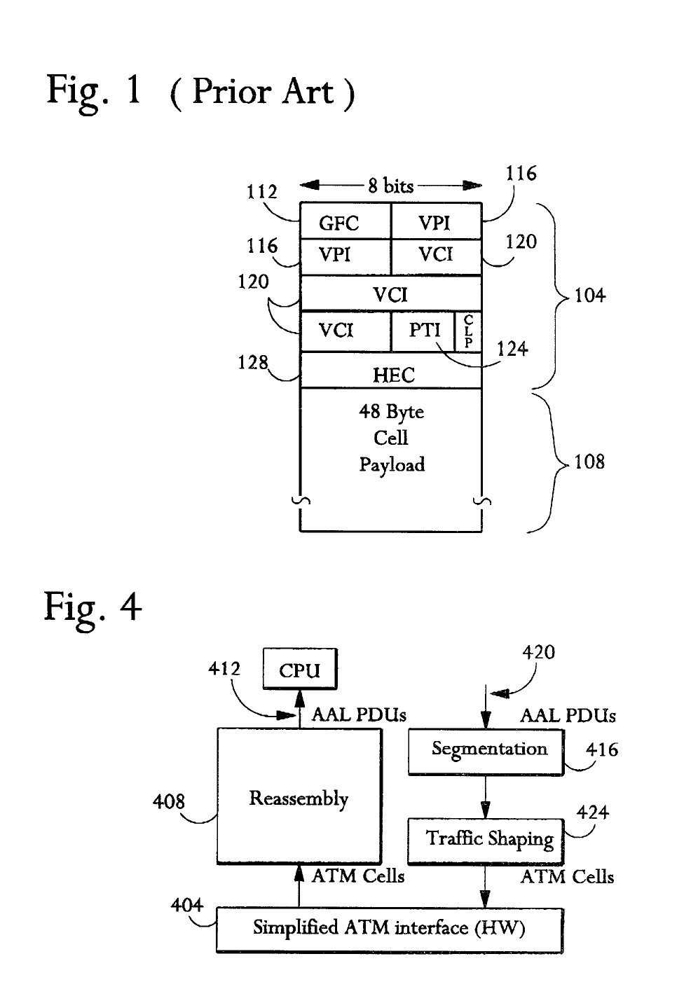

### DETAILED DESCRIPTION OF THE INVENTION

In the following description, a system and apparatus for providing an interface between a transmitting and receiving unit in a network transferring ATM data will be described. The system uses software implemented in a multipurpose central processing unit to form the segmentation and reassembly functions in a personal computer. The use of software to perform the segmentation and reassembly reduces the cost of building a personal computer. The description which follows will include numerous details set forth in order to provide a thorough understanding of the present invention. For example, details will include bus types and specific examples of processors. However, it will be apparent to one skilled in the art that such specific details are not required in order to practice the present invention.

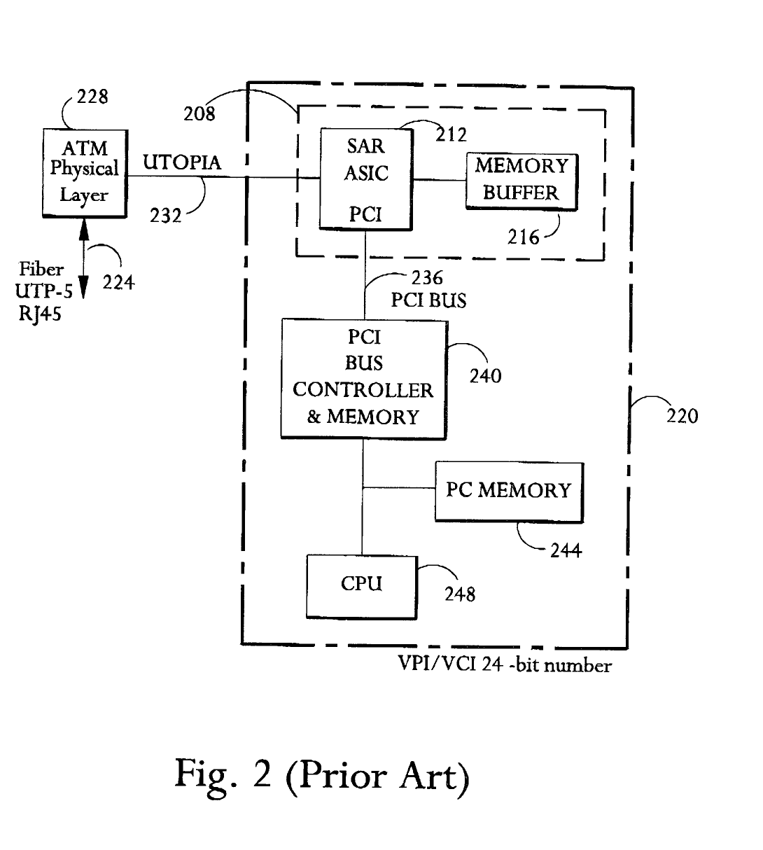

In order to handle the ATM cells, a prior art SAR chip 208 including an SAR ASIC 212 coupled to a memory buffer 216 is implemented in an overall computer system 220 as illustrated in FIG. 2. Computer system 220 receives from a cable 224 such as a fiber or a UTP-5 cable an ATM packet at an ATM physical layer 228. The ATM physical layer 228 performs functions such as bit timing functions, transmission frame adaption to adjust the cell flow according to used payload structure, cell delineation such as scrambling and descrambling to protect the cell delineation mechanism, HEC sequence generation to correct header errors and cell rate decoupling to adapt the rate of ATM cells to payload capacity. Once completed, the ATM physical layer 228 transfers the processed ATM cells along a bus 232 such as a UTOPIA bus to the SAR chip 208. SAR ASIC 212 performs a reassembly of data for transfer to a bus such as a PCI bus 236. Memory buffer 216 coupled to SAR ASIC 212 stores the completed payload data units (PDU) for transfer to the PCI bus 236.

A PCI bus controller 240 controls the flow of data along PCI bus 236. The PCI bus controller 240 receives interrupts when memory buffer 216 is full. The PDUs may be transferred to a PC memory 244 from PCI bus 236 and subsequently to a CPU 248 for processing.

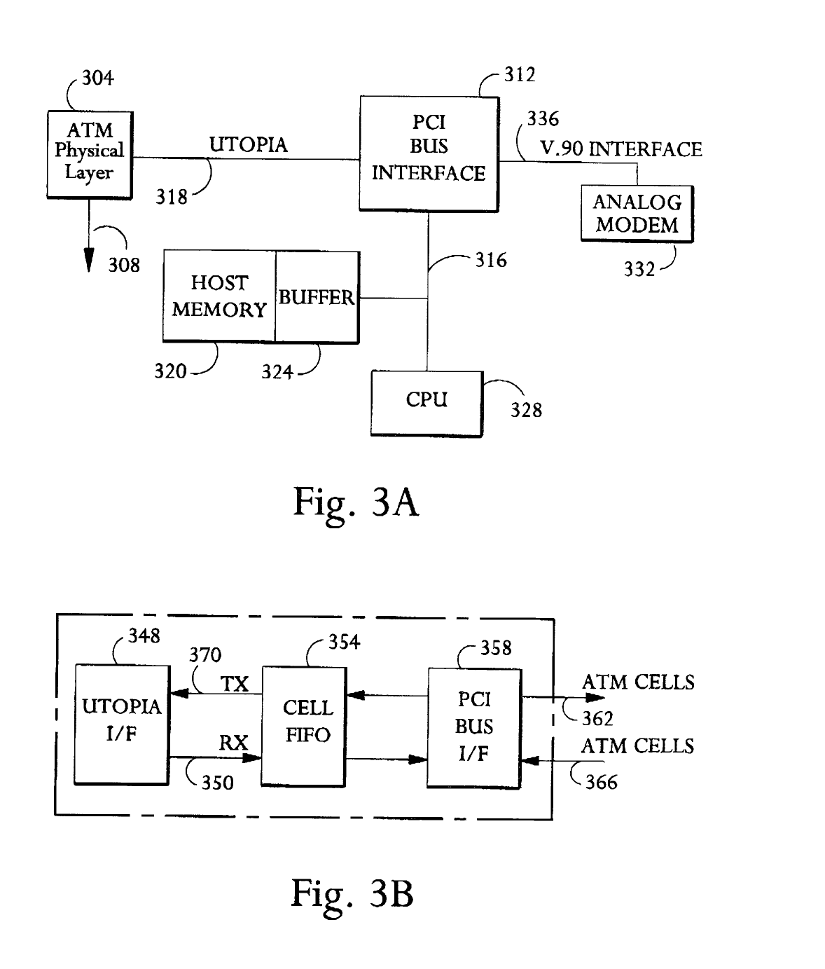

FIG. 3 illustrates an embodiment of the invention in which an ATM physical layer 304 receives data from a cable 308 such as an optical fiber or a UTP-5 cable. The ATM physical layer 304 performs a variety of functions which may include, but is not limited to, bit timing including generation and reception of bit timing information, transmission frame adaption which adapts the cell flow according to the payload structure of the transmission system, cell delineation functions which enable the receiver to recover cell boundaries, header error correction to correct header errors, and cell rate decoupling to remove idle cells during idle periods to adapt the rate of ATM cell transmissions to the payload capacity of the transmission system. A cable such as a UTOPIA bus 308 transfers the output of the ATM physical layer 304 to a PCI bus interface 312. In one embodiment, the PCI bus interface 312 is merely a bridge coupling a PCI bus 316 to a UTOPIA bus 318. The PCI bus 316 is coupled to a host memory 320. A buffer 324, in one embodiment of the invention, a portion of the host memory 320 stores the incoming ATM cells. Typically the ATM cells are concatenated and stored in buffer 324. The size of buffer 324 may vary, a smaller buffer results in more frequency processing of the contents of buffer 324 by a CPU 328 resulting in more interrupts to the CPU. A larger buffer 324 results in fewer interrupts to the CPU 328. However, large buffers result in longer latencies between processing of incoming ATM cells.

The architecture illustrated in FIG. 3 allows the connection of other communication devices such as an analog modem 332 to the PCI bus interface 312 using a typical V.90 PCI interface 336 to transport ATM cells across the system bus. The V.90 interface 336 transports input to the PCI bus 316 through PCI bus interface 312. Once the ATM cells are stored in buffer 324, CPU 328 processes the ATM cells to reassemble the data cells during reception and segments the data prior to transmission. By using a CPU 328 which is typically a general purpose microprocessor such as a Pentium II microprocessor from Intel Corporation of Santa Clara, Calif., significant hardware savings may be had over hardware implementations of a SAR chip.

FIG. 3B illustrates a simplified diagram of the flow of information within the computer system. In FIG. 3B a UTOPIA bus interface 348 receives ATM cells from a network (not shown). The ATM cells are transferred along an ingress direction 350 to a cell First-In First-Out memory (FIFO) 354 which buffers the data. When the CPU is ready to reassemble the ATM data, the content of FIFO 354 is transferred to PCI bus interface 358 for transfer along route 362 to a CPU which performs reassembly and processing of the ATM data.

When outputting data, the CPU continues to generate new data which is associated with header information to form ATM cells and transferred along route 366 to PCI bus interface 358. The ATM cells are stored in a section of FIFO 354 for eventual transfer along egress route 370 to UTOPIA bus interface 348 for output to the network.

FIG. 4 is a block diagram showing the soft SAR module coupled to a simplified ATM interface 404. A reassembly block 408 of the soft SAR receives an incoming stream of ATM cells from one or more ATM virtual circuits (VCs) and reassembles those cells into ATM adaption layer (AAL) protocol data units (PDUs). The AAL protocol PDUs are transferred for output along data path 412 for further processing or for use by the respective processing circuits.

When receiving AAL protocol PDUs, segmentation block 416 receives a stream of AAL protocol PDUs 420 destined for one or more ATM VCs and segments them into ATM cells. A traffic shaping block 424 receives the stream of ATM cells from the segmentation block 416 and outputs a stream of ATM cells for transmission to meet the quality of service (QOS) requirements for each VC and for the entire link.

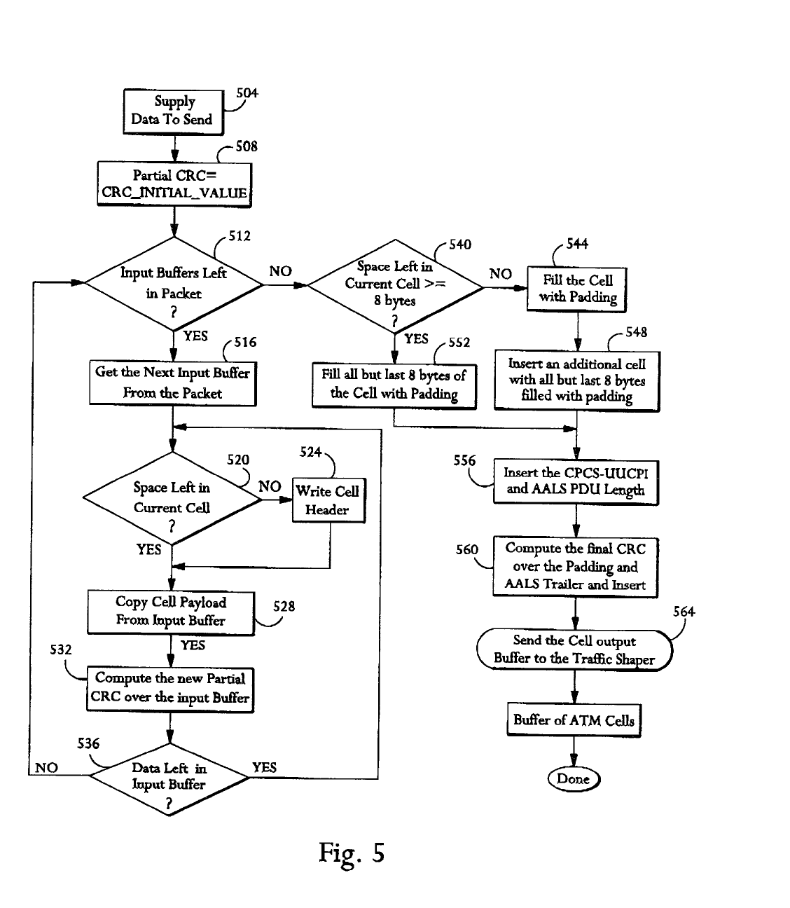

FIG. 5 is a flow diagram illustrating a processor operation to perform the segmentation and traffic shaping functions of segmentation block 416 and traffic shaping block 424 of FIG. 4. In block 504 data to be transmitted is supplied in the form of a packet. Each packet may include one or more input buffers. Prior to beginning segmentation, the partial CRC is set to its initial value in block 508. In block 512, the CPU determines whether there are input buffers left in the packet for segmentation into ATM cells. When there is data remaining in the packet, the CPU obtains the next input buffer of data from the packet in block 516.

In block 520, the CPU determines whether the current cell still has remaining space in the information or payload section of the ATM cell. When the information section of a cell is completely full, the CPU writes the cell header for a new ATM cell in block 524. When the information section of the current cell is not full, the CPU continues to copy cell payload data from the input buffer to the information section of the cell in block 528. In block 532, the CPU computes a new partial cyclic redundancy check (CRC) used to protect against bit errors over the cell payload.

When in decision block 536, the CPU determines that the input buffer is empty, the system goes to decision block 512 to determine whether there are additional input buffers left in the packet. In decision block 512, when it is determined that no more data remains in the packet for transfer to a cell, the system determines whether the information section of the current cell being processed has at least 8 bytes open in block 540. When the current cell does not have at least 8 bytes open, the system pads the remainder of the current cell in block 544 and generates an additional cell filled with padding except for the last 8 bytes in block 548. When open space left in the current cell exceeds 8 bytes, the open space, except for the last 8 bytes, is filled with padding data in block 552. After padding the cell in either block 552 or block 548, the final 8 bytes of the cell are filled with trailer data including, in one embodiment, CPS-UUCPI and AAL5 PDU length in block 556. The final CRC is also computed and inserted into the final 4 bytes of the trailer in block 560. In block 564 the buffer of ATM cells is delivered for traffic shaping.

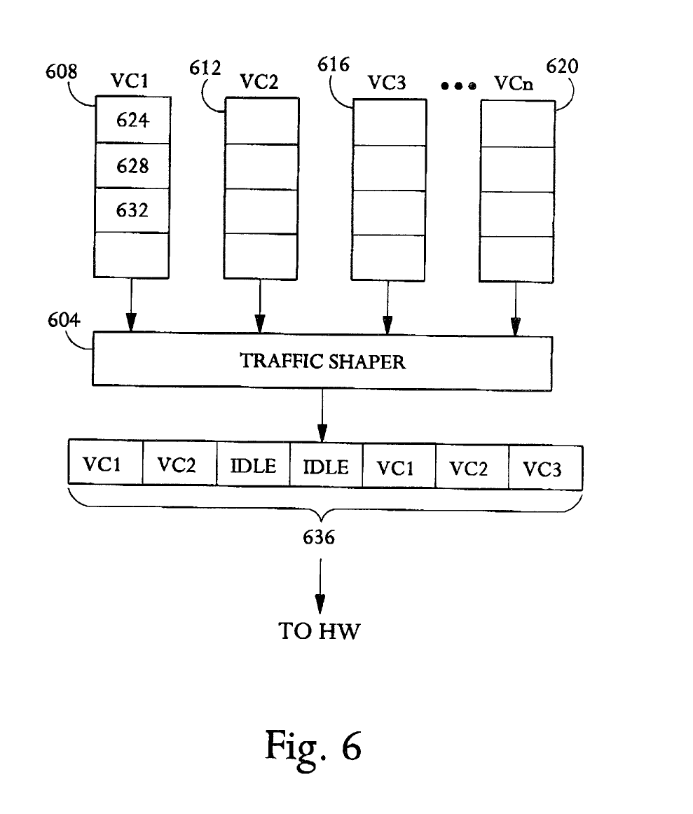

A traffic shaper processes the buffer of ATM cells to direct traffic on a hardware network. FIG. 6 illustrates operation of a traffic shaper 604. Traffic shaper 604 receives a variety of data from a plurality of virtual channels including virtual channel 1 608, virtual channel 2 612, virtual channel 3 616 up to virtual channel N 620. Each virtual channel is formed of a plurality of cell packets such as cell 624, 628, 632 of virtual channel 608. Traffic shaper 604 receives ATM cells from the buffer of ATM cells and transfers them to a hardware network in a concatenated order suitable for a receiving device. One example of a concatenated series of cells is illustrated in output data stream 636.

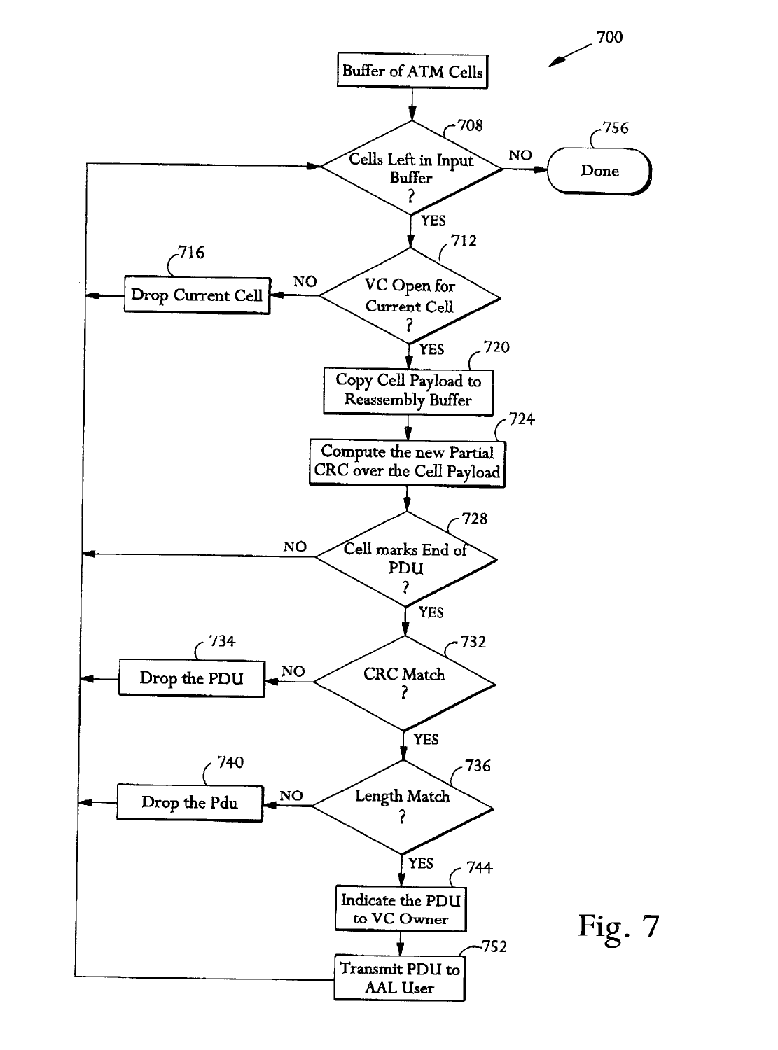

In one embodiment of the invention, the soft SAR is also used to receive data from hardware at a processing unit. The procedure for receiving such data is illustrated in the flow diagram 700 of FIG. 7. In the flow diagram 700 the PCI interface transfers a plurality of ATM cells to a buffer or “input buffer.” The CPU monitors to determine whether there are cells left in the input buffer in block 708. When there are cells in the input buffer, the CPU determines whether there is a virtual channel open for the current cell being processed in block 712. When there is no virtual channel open for the current cell, the current cell is dropped in block 716 and the system returns to block 708 to determine when there are cells left in the input buffer in block 708. If there is a virtual channel open for the current cell in block 712, the CPU copies the cell payload to a reassembly buffer in block 720. After copying the cell payload to a reassembly buffer, a new partial CRC over the cell payload is computed in block 724. When the cell received does not have an end of PDU marker as determined in block 728, the cell is not the last cell in a sequence of data and more data remains to be retrieved so the system returns to block 708 to again retrieve cells from the input buffer.

When the cell contains an end of PDU signal in block 728 indicating that the cell is the last cell in a data sequence, the CPU determines whether a CRC matches in block 732. When no CRC match is found an error occurred during data transfer and a portion of a payload data unit (PDU) received so far is dropped in block 734, the system returns to block 708 to determine a number of retrieved cells remaining in the input buffer in block 708. When a CRC match is found in block 732, the CPU determines whether there is a length match in block 736. When the length of the payload data unit does not match the indication for the expected length an error has occurred and the PDU is dropped in block 740. The system returns to determine a number of retrieved cells remaining in the input buffer in block 708.

When in block 730 the lengths match, the system transfers the PDU to a virtual channel (VC) owner in block 744. In alternate embodiments, the PDU may also be transmitted to an AAL user in block 752. Thus, the software of the system receives the ATM cells and reassembles the data packets transferring only PDUs to the VC owner or to the appropriate AAL user. The process continues until no cells are found in the input buffer of block 708 in which case the system has completed in data transfer block 756.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

What is claimed is:

1. A method of performing asynchronous transfer mode (ATM) segmentation functions comprising the operations of:
receiving data to send;
segmenting the data to generate a plurality of ATM cells;
buffering the plurality of ATM cells in a memory device;
traffic shaping the buffered plurality of ATM cells; and
transmitting the plurality of ATM cells on a network.

2. The method of claim 1 wherein the traffic shaping further comprises:
examining a virtual channel and determining whether a cell should be output at a given time; and
updating virtual channel information when a cell is to be output at the given time.

3. The method of claim 1 wherein the operation of segmenting data is performed by a central processing unit (CPU) of a computer.

4. The method of claim 1 wherein the traffic shaping of data is performed by a central processing unit (CPU) of a computer.

5. A program storage device readable by a machine, tangibly embodying a program of instructions executable by a machine to perform method steps for segmenting asynchronous transfer mode (ATM) data, the program comprises:
a first code section to instruct a CPU of a computer to segment data to generate a plurality of ATM cells;
a second code section to buffer the plurality of ATM cells in a memory device; and
a third code section to traffic shape the buffered plurality of ATM cells.

6. The program storage device of claim 5 wherein the first code section includes instructions to examine a virtual channel and determine whether a cell should be output at a given time and to update virtual channel information when a cell is to be output at the given time.

7. The program storage device of claim 5 wherein the program further comprises:
a fourth code section to compute a new partial cyclic redundancy check used to protect against bit errors.

8. The program storage device of claim 5 wherein the program includes instructions to pad ATM cells which are not complete.

9. A method of performing asynchronous transfer mode (ATM) reassembly functions comprising:
receiving in an uninterrupted stream a plurality of protocol data units without interrupt in an input buffer, each protocol data unit including a plurality of ATM cells; and
retrieving ATM cells from the input buffer until all data corresponding to a payload data unit is retrieved and checking a CRC to determine whether data was received without error.

10. The method of claim 9 further comprising:
dropping the payload data unit when the CRC indicates an error.

11. The method of claim 9 further comprising:
copying a cell payload from the input buffer into a reassembly buffer.

12. The method of claim 11 further comprising:
calculating a new partial CRC corresponding to the cell payload.

13. The method of claim 11 further comprising:
determining whether the cell payload includes an end of payload data unit marker; and copying a second cell payload from the input buffer into the reassembly buffer when retrieved cell payload does not include the end of payload data unit marker.

14. A program storage device readable by a machine tangibly embodying a program of instructions executable by a machine to perform method steps for reassembly ATM data, the program comprising:
a first code section to receive a stream including a plurality of protocol data units without interrupt in an input buffer, each protocol data unit including a plurality of ATM cells.

15. The program storage device of claim 14 further comprising:
a second code section to retrieve ATM cells from the input buffer until all data corresponding to a payload data unit is retrieved and checking a CRC to determine whether data was received without error.

16. The program storage device of claim 14 further comprises:
a second section to copy a cell payload from the input buffer into a reassembly buffer.
